(19) United States
(12) Patent Application Publication
(10) Pub. No.: US 2020/0312135 A1
(43) Pub. Date: Oct. 1, 2020

(54) HAND HOLDABLE AUTONOMOUS COUNTDOWN DEVICE

(71) Applicant: Elven Moshi, Temecula, CA (US)

(72) Inventor: Elven Moshi, Temecula, CA (US)

(21) Appl. No.: 16/367,614

(22) Filed: Mar. 28, 2019

(51) Int. Cl. G08G 1/096; G08B 5/00

(52) U.S. Cl. CPC G08G 1/096; G08B 5/006

(57) ABSTRACT

A hand holdable automatic countdown device comprises a panel having a first side and an opposing second side. A bi-directional display is coupled to the panel and is capable of emitting a visual signal in opposite directions away from the first side and the second side, with the visual signal being representative of a countdown. An actuator is coupled to the panel and capable of being selectively actuated by a user. A controller is in operative communication with the actuator and the display, with the controller being configured to generate a display command signal in response to actuation of the actuator by the user. The display receives the display command signal from the controller and emits the visual command signal in response thereto, with the display automatically transitioning to an OFF state upon completion of the countdown.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a digital countdown device, and more specifically, to a hand holdable digital countdown device usable in a vehicle to provide a visual countdown signal to two drivers in adjacent vehicles.

### 2. Description of the Related Art

Auto racing typically involves racing at least two vehicles over a known distance. Drivers oftentimes engage in auto racing for the thrill of high-speed driving and competition. The integrity and fairness of a given race may depend on the racers starting the race at the same time. As such, there may criticality in providing a starting signal or other notification to the racers.

Many auto races, such as drag races, begin with two vehicles at rest behind a start line. Once both vehicles are in place, a visual cue may be provided to the drivers to signify the beginning of the race. Some race facilities may include a light pole, often referred to as a “Christmas tree,” with the light pole being fixed between a pair of parallel racing lanes. The light pole is positioned slightly in front of the start line so that both drivers can see the light pole. The lights on the pole illuminate to provide the visual cue to the drivers that the race has started.

While the light pole may provide a suitable visual cue to both drivers, there may be inherent drawbacks to the light pole that prevent universal adoption thereof. In particular, the light pole may not be portable, and thus, may require a dedicated installation location, as well as electrical hard-wiring to power the light pole.

For raceways without a light pole, other visual cues may be used to provide a visual alert to the drivers signifying the start of a race. A flag may be used to provide the visual cue, wherein an individual may stand with the flag between both vehicles. The flag may be raised overhead prior to the start, and then dropped to signify the start of the race. If no flag is available, the individual may simply raise and then lower his hands.

Although the use of a flag or one's hands may provide a start signal for a race, there are drawbacks associated therewith. For instance, there may be an inherent risk to the individual standing between the two vehicles, as the vehicles may inadvertently hit the individual, or in the case of a mechanical failure, a part of a vehicle may strike the individual. Another drawback is the dependency of a non-racing individual to provide the start signal. Thus, if only the two drivers are present, no one may be able to provide the start signal.

Accordingly, there is a need in the art for an improved starter device that provides a visual signal to both drivers, can be used on-the-fly, and does not rely on the existence of a non-driving individual to provide the signal. Various aspects of the present disclosure address this particular need, as will be discussed in more detail below.

### BRIEF SUMMARY

Various aspects of the present disclosure are related to a hand holdable countdown device that can be selectively actuated for providing a countdown signal that is viewable in two opposite directions. For instance, the countdown signal may be viewable by two automobile drivers in side-by-side vehicles. The countdown device may include a handle coupled to a display panel, with the handle being easily grippable by a user to raise the countdown device into view by an adjacent viewer. A button may be selectively actuatable by the user to start the countdown signal, which when actuated, may proceed through a predefined countdown, and then automatically power off. The hand-holdable configuration of the countdown device may allow the countdown device to be used on-the-fly. Furthermore, the ability to transition to an ON state, generate and display the countdown signal, and then transition to an OFF state or sleep state in response to a single activation by a user makes the countdown device extremely user friendly.

In accordance with one embodiment of the present disclosure, there is provided a hand holdable automatic countdown device comprising a panel having a first side and an opposing second side. A bi-directional display is coupled to the panel and is capable of emitting a visual signal in opposite directions away from the first side and the second side, with the visual signal being representative of a countdown. An actuator is coupled to the panel and capable of being selectively actuated by a user. A controller is in operative communication with the actuator and the display, with the controller being configured to generate a display command signal in response to actuation of the actuator by the user. The display receives the display command signal from the controller and emits the visual command signal in response thereto, with the display automatically transitioning to an OFF state upon completion of the countdown.

The panel may be transparent. The panel may be quadrangular, triangular, or ovular, in shape.

The display may include a plurality of light emitting diodes (LEDs) coupled to the panel.

The countdown may include a sequential illumination of 3, 2, 1.

The countdown device may additionally include a handle connected to the panel. The handle may be detachably connected to the panel.

The countdown device may further comprise at least one camera coupled to the panel, with the camera being transitioned to an ON state in response to the actuator being actuated remaining in the ON state for a prescribed period of time, and then transitioning to an OFF state.

The countdown device may additionally include at least one light strip coupled to the panel, the light strip being configured to illuminate a prescribed color sequence in response to the actuator being actuated by the user.

The countdown device may further comprise at least one suction cup coupled to the panel. The countdown device may also include a strap coupled to the panel.

According to another embodiment, there is provided a countdown device comprising a manually transportable panel and a multi-directional display coupled to the panel and capable of emitting a visual signal in at least two opposite directions. A controller is in operative communication with the multi-directional display, the controller being configured to actuate the multi-directional display and operate the multi-functional display in accordance with a defined program in response to receipt of a user-initiated activation signal, the defined program including automatically transitioning the display to an OFF state after emitting the visual signal.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a countdown device being held by a first driver for viewing by the first driver and an adjacent second driver;

FIG. 2 is a front view of the countdown device;

FIG. 2A is a cross sectional view of the countdown device depicted in FIG. 2;

FIG. 3 is a schematic diagram of the electrical components of the countdown device;

FIG. 4 is a front view of the countdown device including a strap and suction cups to facilitate mounting in a vehicle; and

FIG. 5 is a top view of two vehicles side-by-side, with the countdown device being positioned so as to be viewable by the drivers of the vehicles;

Common reference numerals are used throughout the drawings and the detailed description to indicate the same elements.

### DETAILED DESCRIPTION

Referring now to the drawings, wherein the showings are for purposes of illustrating a preferred embodiment of the present disclosure, and is not for purposes of limiting the same, there is depicted a hand-holdable countdown device 10 operative to display a countdown signal in two opposite directions. The countdown device 10 may be easily raised and positioned in the field of view of two individuals, such as two drivers of respective vehicles. The countdown device 10 may be user activated to display a pre-programmed countdown signal having a readily understood end point, which may be representative of a signal to begin a race. For instance, the countdown signal may be a visual depiction of “3” then “2” then “1” and then “GO”. Once the countdown has been completed, the countdown device 10 may automatically transition to an OFF state or a sleep state to conserve power.

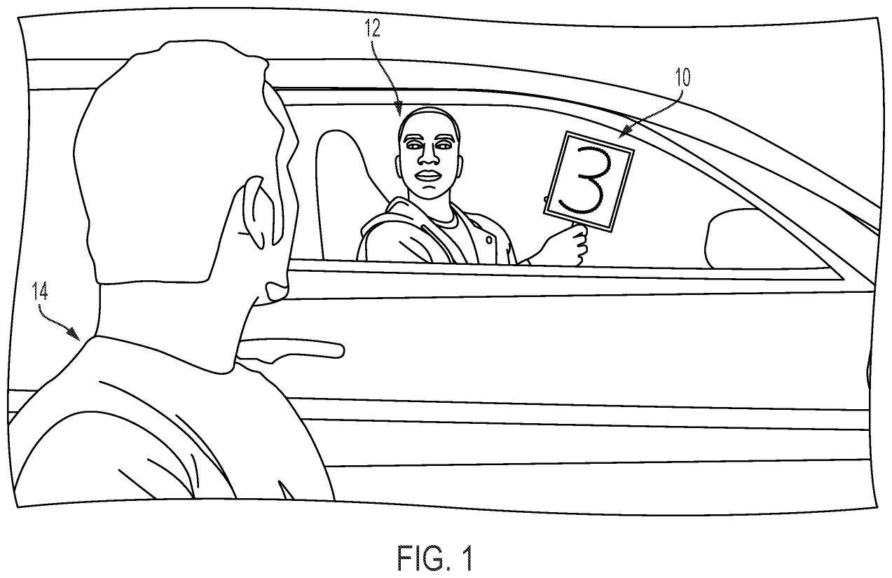

FIG. 1 shows the countdown device 10 being held by a driver 12 of a first vehicle, with the countdown device 10 being positioned in a manner which allows a driver 14 in an adjacent vehicle to also view the countdown device 10. From the perspective shown in FIG. 1, the countdown device 10 is depicting a “3”, which can be seen by the driver 14. The opposite side of the countdown device 10, may also depict a “3” which can be seen by driver 12. The signals displayed on both sides of the countdown device 10 are synchronized so as to simultaneously depict the same image or depiction.

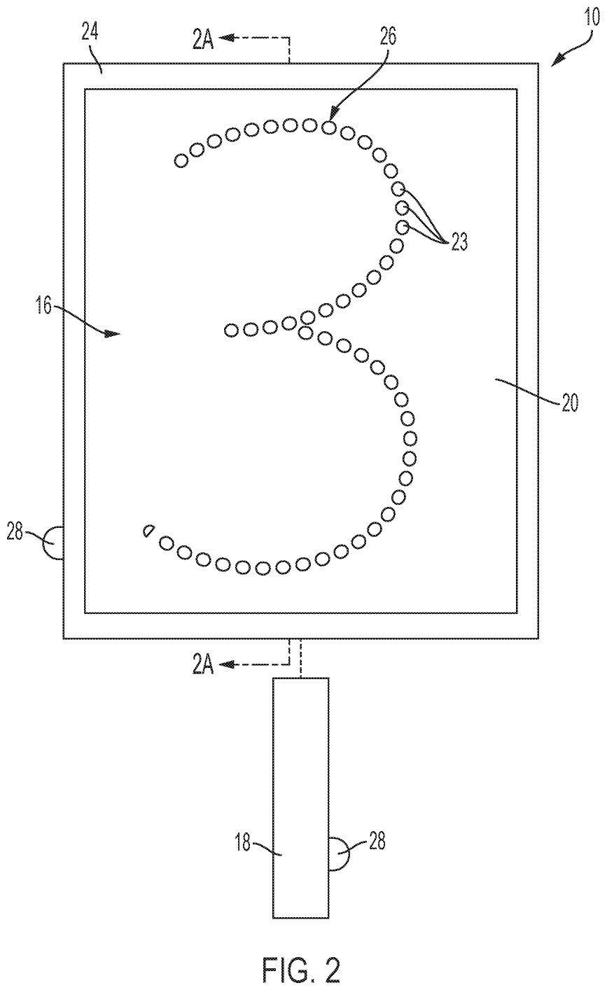

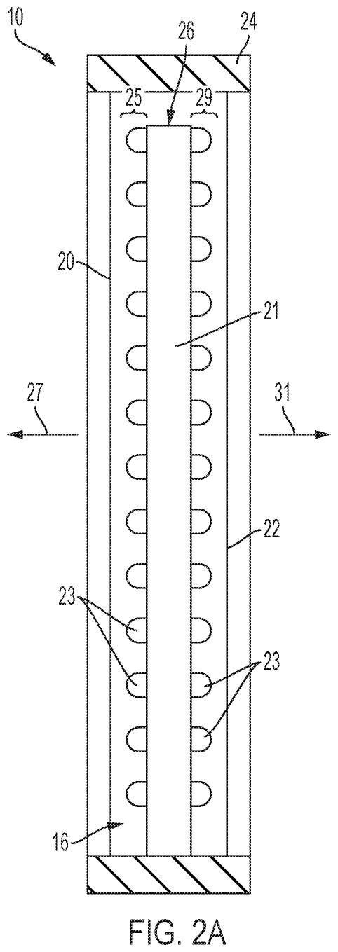

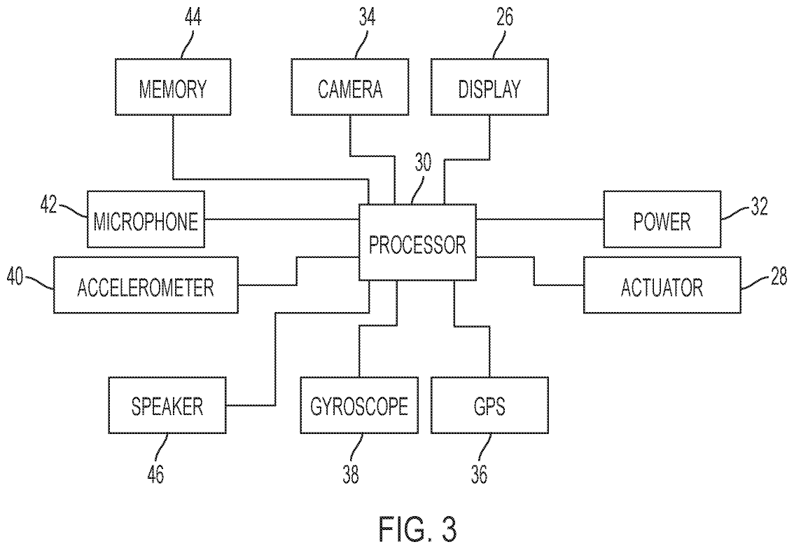

According to one embodiment, and referring now to FIGS. 2 and 3, the countdown device 10 includes a panel 16 and a handle 18 connected to the panel 16. As shown in the Figures, the panel 16 is quadrangular and includes a planar first side 20 and an opposing planar second side 22. The panel 16 may be transparent, to allow for viewing therethrough, or alternatively, the panel may not be transparent. The panel 16 may be formed of plastic, plexiglass, rubber, metal, wood, or other materials known in the art. A border 24 may be coupled to the periphery of the panel 16, and may be designed to offer protection to the panel 16, while also framing the signal displayed on the panel 16 to facilitate viewing of the signal. The protection provided by the border 24 may be critical to protect the panel 16 in the event the countdown device 10 is quickly dropped, such as once a race starts, or is jostled around in a fast-moving vehicle. The border 24 may be fabricated from carbon-fiber, rubber, plastic, or other materials known in the art. The border 24 may be molded onto the panel 16, coupled to the panel via adhesives or mechanical fasteners.

The panel 16 may generally be the size of a standard sheet of paper, e.g., 8.5 inches by 11 inches. However, other sizes are also contemplated, such as 5 inches by 7 inches, 4 inches by 6 inches, 6 inches by 6 inches, etc. In this regard, the panel 16 may have a width between 3-20 inches, and a length of between 3-20 inches. Although the foregoing describes the panel 16 as being quadrangular in shape, the panel 16 may be configured in other shapes, such as quadrangular, triangular, or ovular in shape.

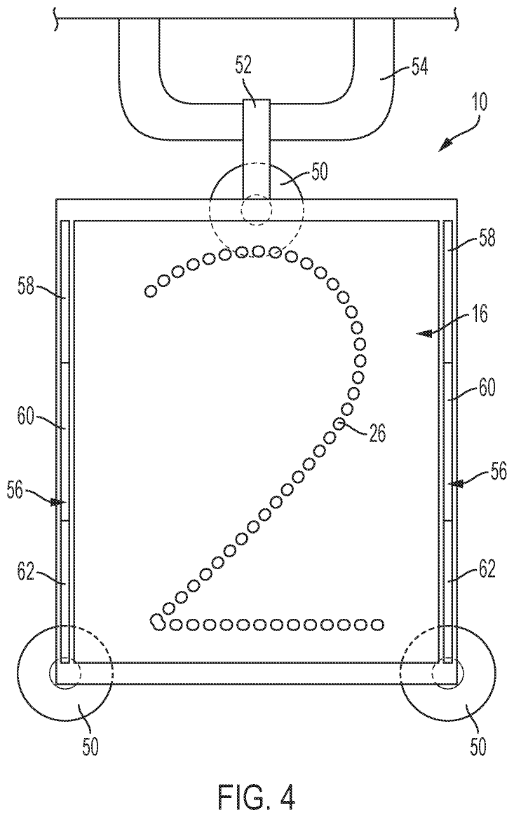

A multi-directional display 26 may be coupled to the panel 16 to allow the displayed content to be viewed by drivers of both vehicles. The display 16 may include a plurality of light emitting diodes (LEDs) 23 mounted to a display board 21, with LEDs 23 capable of being selectively actuated to display desired content. For instance, in FIG. 2, a plurality of LEDs 23 are actuated to display a “3”, whereas in FIG. 4, the LEDs 23 are actuated to display a “2.” The display 26 may include two sets 25, 29 of LEDs 23, or other light emitting devices, to display the desired content in two opposite directions. FIG. 2A depicts a cross section of the panel-display assembly, wherein the display 26 includes a first set 25 of LEDs 23 for generating a visual signal in a first direction 27, and a second set 29 of LEDs 23 for generating a visual signal in a second direction 29 opposite the first direction 27. For more information regarding multi-directional digital displays, please refer to U.S. Pat. No. 7,473,020 entitled Light Emitting Diode Display System, the contents of which are expressly incorporated herein by reference.

Although the exemplary embodiment includes LEDs 23, other digital display technologies may also be used without departing from the spirit and scope of the present disclosure. For instance, the display 26 may utilize liquid crystal cells to display content, as well as other digital display technologies known by those skilled in the art.

As noted above, the countdown device 10 may include a handle 18 connected to the panel 16. The handle may include an elongate, hand-grippable rod or other similar structure that is sized to allow an adult to easily grasp. In one embodiment, the handle 18 is permanently mounted to the panel 16 via mechanical fasteners, adhesives, etc. As shown, the handle 18 extends from the center-bottom of the panel 16, although the position of the handle 18 is not limited thereto. In an alternative embodiment, the handle 18 is detachably connected to the panel 16. For instance, the handle 18 may include an externally threaded end portion which may engage with an internally threaded bore on the panel 16 to facilitate detachable coupling thereto. Other forms of detachable coupling known in the art, such as detent pins, etc., may also be employed.

The handle 18 may be of a fixed length, i.e., the distance which the handle 18 extends from the panel 16, or alternatively, the handle 18 may be extendable to allow for adjustment of the length. For instance, the handle 18 may be telescopic, or may include segments which may be selectively added or removed from the handle 18 to adjust the overall length thereof.

An actuator 28 may be coupled to the panel 16 and capable of being selectively actuated by a user to start the display countdown. The actuator 28 may be a button, toggle, switch, or other actuation mechanism known in the art. The embodiment depicted in FIG. 2 includes an actuator 28 extending outwardly from the border 24, and another actuator 28 on the handle 18. Although the device 10 in FIG. 2 includes two actuators 28, only one actuator 28 need be actuated to begin the countdown signal. The use of two actuators 28 may simply provide alternative locations on the device 10 to provide convenience to the user. For instance, the actuator 28 extending from the border 24 may be particularly useful when the handle 18 is disconnected, in which case the actuator 28 on the handle 18 may be operatively disconnected. It is understood that on some embodiments, the countdown device 10 may include only one actuator 28, which may be located anywhere on the device 10.

With the basic structure of the device 10 described above, the following discussion relates to an exemplary use of the device 10. When the vehicles driven by the first and second drivers 12, 14 are side-by-side and ready to start a race, the first driver 12 grabs the handle 18 on the countdown device 10 and raises the countdown device 10 such that the display 26 is in the field of view of both drivers 12, 14. The first driver 12 then presses the actuator 28, which causes the display 26 to illuminate. In this regard, prior to being actuated, the display 26 may be in a dormant or OFF mode, so as to conserve power. Thus, when the actuator 28 is pressed, the processor 30 may divert power to the display 26, as well as transmit the display command signal to the display 26.

In response to receiving the display command signal, the display 26 transitions to an ON mode and displays the countdown in accordance with the display command signal. As the countdown is displayed, both drivers 12, 14 remain ready to begin the race. The end of the countdown signifies the start of the race. As such, the displayed countdown may proceed as “3-2-1-GO,” “3-2-1-0,” “3-2-1-→.” Alternatively, the displayed countdown may include a numeric countdown, e.g., “3-2-1” which is then followed by the illumination of one or more green circles to signify the start of the race. Indeed, any combination of alphanumeric characters, shapes, and symbols may be used to signify the start of the race.

The final portion of the display signal, e.g., “GO,” may remain illuminated for a predetermined period of time, such as 1-10 seconds, and more preferably, about 3 seconds, before turning off. In this regard, the countdown device 10 may automatically return to the OFF state at the expiration of the predetermined period of time so as to conserve energy.

The countdown device 10 may allow drivers to quickly and easily provide a fair start signal for a race. As such, when a race is to be conducted at a facility without a dedicated light column or other starting apparatus, the countdown device 10 may be used start the race. Furthermore, the countdown device 10 may be used by either one of the drivers, and thus, does not require a separate individual for operation.

Referring now to FIG. 3, there is depicted an electrical schematic of an embodiment of the countdown device 10. In the embodiment depicted in FIG. 3, in addition to the display 26 and actuator 28 discussed above, the countdown device 10 may include a processor 30, a power source 32, one or more cameras 34, a GPS module 36, a gyroscope 38, an accelerometer 40, a microphone 42, a memory module 44, and a speaker 46.

The processor 30 may include any processor known in the art and may be in operative communication with the actuator 28 and the display 26. In particular, the processor 30 may receive an activation signal from the actuator 28 and generate a display control signal in response to receiving the activation signal. The display control signal may be transmitted from the processor 30 and received by the display 26, which may operate in accordance with the display control signal.

The power source 32 may be in operative communication with the processor 30 and may include batteries, which may be replaceable or rechargeable. In the case of rechargeable batteries, a charging port, e.g., a mini-USB port, may be incorporated into the countdown device 10. The power source 32 may be located in the handle 18 and/or the panel 16. Accordingly, any power port may also be incorporated into the handle 18 and/or the panel 16.

The camera 34 may be mounted on the panel 16 and may capture images and/or video of one or more vehicles during the race, as will be described in more detail below. The camera 34 may be in electrical communication with the processor 30 such that the processor 30 may send operational instructions and power to the camera 34, while the camera 34 may send data to the processor 30.

The GPS module 36 may be mounted to the panel 16 and may provide location information for the countdown device 10. The location information may be used to calculate speed of the vehicle in which the countdown device is located, e.g. distance/time. The location information may also be used to label data related to a particular race. For instance, the race data may be at least partially labeled by city, zip code, longitude/latitude coordinates, etc.

The gyroscope 38 may be mounted to the panel 16 and capable of detecting changes in orientation of the countdown device 10, which may be used as an operational trigger. For instance, the gyroscope 38 may be able to detect the countdown device 10 being raised and lowered and send a signal representative of such change to the processor 30. In turn, the processor 30 may send display control signals to the display 26. Thus, the gyroscope 38 may be used in place of the actuator 28 or as a substitute for the actuator 28. Furthermore, in the case of the gyroscope 38 detecting lowering of the countdown device 10, the processor 30 may use such detection as a trigger to transition the display 26 to the OFF or dormant state. The detections made by the gyroscope 38 may be used as triggers to control any of the other electrical components on the device 10.

The accelerometer 40 may be coupled to the panel 16 and may detect a change in acceleration of the countdown device 10. The change in acceleration may be used to record race related data, such as acceleration of the vehicle within which the countdown device 10 is located. The data generated by the accelerometer 40 may also be used in a manner similar to the gyroscope 38 discussed above, wherein the accelerometer data is used as an operational trigger for controlling operation of one or more electrical components on the countdown device 10.

The microphone 42 may be coupled to the panel 16 and detect sounds adjacent the countdown device 10. In this regard, the microphone 42 may detect verbal instructions or dialogue of the driver or other occupants within the vehicle. In this regard, the signals detected by the microphone 42 may be used to control operation of the countdown device 10. For instance, the countdown device 10 may be capable of operating in response to verbal commands from the driver, or in response to sounds associated with operation of the vehicle. For instance, the microphone 42 may detect a sudden increase in noise produced by the engine, which may be indicative of the race starting, which may be used as a trigger to transition the countdown device 10 into the OFF or dormant state.

The memory module 44 may be coupled to the panel 16 and may include preprogrammed instructions, such as preprogrammed display instructions, which may be used by the processor 30 to generate the display control signal. The memory module 44 may also be used to store data generated by any of the other electrical components, as well as command instructions for such components.

The speaker 46 may be coupled to the panel 16 and capable of providing audible cues to the driver. For instance, the speaker 46 may generate a sound upon activation of the countdown device 10, at each step of the countdown, and upon transition of the countdown device 10 to the OFF or dormant state.

Referring now to FIG. 4, there are several accessories that may be included with the countdown device 10 for mounting the panel 16 within the vehicle. In one embodiment, one or more suction cups 50 may be coupled to the panel 16 and used to secure the countdown device to a window positioned between the drivers. In another embodiment, one or more straps 52 may be used to hang or couple the countdown device 10 to a structure on the vehicle, such as a handle 54.

FIG. 4 also depicts an alternative embodiment of the display 26, which, in addition to including the LEDs, also includes a pair of light strips 56 coupled to the panel 16. In particular, the light strips 56 are integrated into the border 24 to provide a peripheral display signal. However, it is understood that the location of the light strips 56 is not limited to the border 24 and may be integrated into other portions of the countdown device 10. The light strip 56 being configured to illuminate a prescribed color sequence in response to the actuator being actuated by the user. To that end, the light strip 56 may be comprised of a first region 58, a second region 60, and a third region 62. The first region 58 may depict a first color, such as red, the second region 60 may depict a second color, such as yellow, and the third region 62 may depict a third color such as green. The countdown signal may include illuminating the first color, and then the second color, and finally the third color.

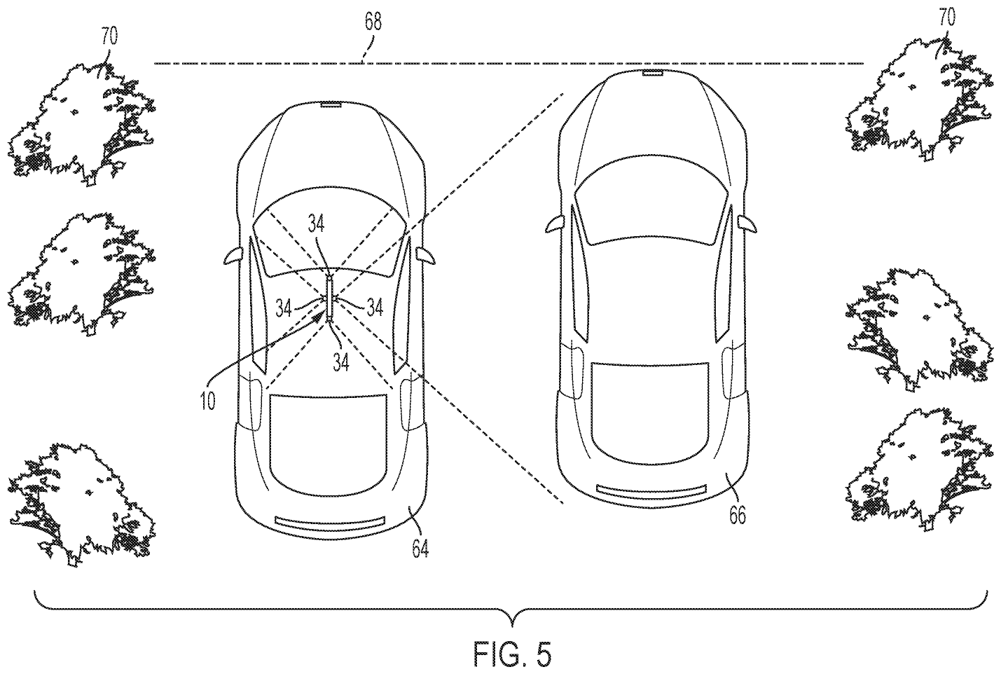

FIG. 5 is a top view of the device 10, located within a vehicle 64, with vehicle 66 positioned adjacent vehicle 64. The device 10 in FIG. 5 includes four cameras 34 to capture video or images in a forward direction, a rearward direction, a left side direction and a right, side direction. In this regard, the cameras 34 provide substantially 360 degrees of view. The cameras 34 may capture the position of both vehicles 64, 66 relative to a start line 68, which may be a physical start line, or a virtual start line, or the position of the vehicles 64, 66 relative to environmental structures, such as nearby trees 70, buildings, fences, etc. As such, the cameras 34 may provide an account of the race to ensure both vehicles 64 did not false start, e.g., cross the start line 68 before the countdown signal ended. In this regard, the processor on the device 10 may be capable of analyzing the content from the cameras 34 and comparing the content with the countdown signal to ensure prohibited movement of the vehicles 64, 66 is not detected. If such movement is detected, the device 10 the processor may generate a false start signal, which may be received by the display 26, and in turn, the display 26 may generate a visual false start signal, e.g., an “X” or “FASLE START”. Alternatively, if no prohibited motion is detected, the processor may generate an all clear signal, which may be received by the display 26, and in turn, the display 26 may generate a visual all clear signal, e.g., a checkmark or “ALL CLEAR.”

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

1. A hand holdable automatic countdown device comprising:
a panel having a first side and an opposing second side;
a bi-directional display coupled to the panel and capable of emitting a visual signal in opposite directions away from the first side and the second side, the visual signal being representative of a countdown;
a gyroscope coupled to the panel and configured to detect a change in orientation of the panel and generate an actuation signal in response to a detected change in orientation of the panel;
and
a controller in operative communication with the gyroscope and the display, the controller being configured to generate a display command signal in response to receipt of the actuation signal from the gyroscope;
the display receiving the display command signal from the controller and emitting the visual signal in response thereto, the display automatically transitioning to an OFF state upon completion of the countdown.

2. The countdown device recited in claim 1, wherein the panel is transparent.

3. The countdown device recited in claim 1, wherein the display includes a plurality of light emitting diodes (LEDs) coupled to the panel.

4. The countdown device recited in claim 1, wherein the countdown includes a sequential illumination of 3, 2, 1.

5. The countdown device recited in claim 1, further comprising a handle connected to the panel.

6. The countdown device recited in claim 5, wherein the handle is detachably connected to the panel.

7. The countdown device recited in claim 1, further comprising at least one camera coupled to the panel and in operative communication with the controller, the camera being transitioned to an ON state in response to receipt of the actuation signal at the controller from the gyroscope, the camera remaining in the ON state for a prescribed period of time, and then transitioning to an OFF state.

8. The countdown device recited in claim 1, further comprising at least one light strip coupled to the panel and in operative communication with the controller, the light strip being configured to illuminate a prescribed color sequence in response to receipt of the actuation signal by the controller.

9. The countdown device recited in claim 1, further comprising at least one suction cup coupled to the panel.

10. The countdown device recited in claim 1, further comprising a strap coupled to the panel.

11. (canceled)

12. A countdown device comprising:
a manually transportable panel;
a multi-directional display coupled to the panel and capable of emitting a visual signal in at least two opposite directions;
a gyroscope coupled to the panel and configured to detect a change in orientation of the panel and generate an activation signal in response to a detected change in orientation of the panel; and
a controller in operative communication with the multi-directional display and the gyroscope, the controller being configured to actuate the multi-directional display and operate the multi-functional display in accordance with a defined program in response to receipt of the activation signal, the defined program including automatically transitioning the display to an OFF state after emitting the visual signal.

13. The countdown device recited in claim 12, wherein the panel is transparent.

14. The countdown device recited in claim 12, wherein the display includes a plurality of light emitting diodes (LEDs) coupled to the panel.

15. The countdown device recited in claim 12, wherein the countdown includes a sequential illumination of 3, 2, 1.

16. The countdown device recited in claim 12, further comprising a handle connected to the panel.

17. (canceled)

18. The countdown device recited in claim 12, further comprising at least one camera coupled to the panel, the camera being transitioned to an ON state in response to the actuator being actuated remaining in the ON state for a prescribed period of time, and then transitioning to an OFF state.

19. The countdown device recited in claim 12, further comprising at least one suction cup coupled to the panel.

20. The countdown device recited in claim 12, further comprising a strap coupled to the panel.

21. The countdown device recited in claim 1, further comprising a GPS module in operative communication with the controller and configured to detect a position of the countdown device.

22. The countdown device recited in claim 7, wherein the at least one camera captures a plurality of images capable of being used to detect motion of the countdown device, the controller being configured to receive the plurality of images, analyze the images to determine motion of the countdown device, compare the determined motion of the countdown device with the emitting of the visual signal, and generate an alert when it is determined that the detected motion occurs before the emitting of the visual signal.
